(19) United States
(12) Patent Application Publication
(10) Pub. No.: US 2010/0156226 A1
(43) Pub. Date: Jun. 24, 2010

(54) BRUSH TYPE MOTOR

(75) Inventors: Mohammad S. Islam, Saginaw, MI (US); Matthew W. Mielke, Freeland, MI (US); Christian Ross, Hemlock, MI (US)

Correspondence Address: Cantor Colburn LLP-General Motors, 20 Church Street, 22nd Floor, Hartford, CT, 06103, US

(73) Assignee: GM GLOBAL TECHNOLOGY OPERATIONS, INC., Detroit, MI (US)

(21) Appl. No.: 12/642,061

(22) Filed: Dec. 18, 2009

Related U.S. Application Data
(60) Provisional application No. 61/139,111, filed on Dec. 19, 2008.

(51) Int. Cl. H02K 23/04; H02K 1/16

(52) U.S. Cl. 310/154.21; 310/216.094

(57) ABSTRACT

A brush type motor including a stator having at least one magnet with an inner circumferential surface is provided. The inner circumferential surface is defined by a first radius orthogonally extending from a first axially extending centerline. The motor has an armature disposed within an interior region of the stator having teeth. Each tooth has an arcuate surface defined by a second radius orthogonally extending from a second axially extending centerline. At least one tooth is radially closer to the inner circumferential surface than the teeth adjacent to the at least one tooth. Each tooth further includes at least one dummy notch extending into the tooth. The first axially extending centerline is in a first position different than a second position of the second axially extending centerline.

### CROSS-REFERENCE TO RELATED APPLICATIONS

This application claims the benefit of U.S. Provisional Patent Application Ser. No. 61/139,111 filed Dec. 19, 2008, the contents of which are incorporated by reference herein.

### FIELD OF THE INVENTION

Exemplary embodiments of the present invention are related to a brush type motor and, more specifically, to a brush type motor having reduced cogging torque.

### BACKGROUND

In electric power steering systems, an assist torque is provided by an electric motor through a gear reduction mechanism. The motor can be either brush type or brushless. Due to relatively low costs and simple control requirements, the brush type permanent magnet (PM) motors are gaining attention for high performance applications such as electric power steering. Due to use of PM motors, any undesirable cogging torque must be addressed for steering or ripple sensitive applications.

### SUMMARY OF THE INVENTION

In one exemplary embodiment of the present invention, a brush type motor including a stator having at least one magnet with an inner circumferential surface is provided. The inner circumferential surface is defined by a first radius orthogonally extending from a first axially extending centerline. The brush type motor further includes an armature disposed within an interior region of the stator. The armature has a plurality of teeth. Each tooth of the plurality of teeth has an arcuate surface defined by a second radius orthogonally extending from a second axially extending centerline. At least one tooth of the plurality of teeth is radially closer to the inner circumferential surface of the at least one magnet than the plurality of teeth adjacent to the at least one tooth. Each tooth of the plurality of teeth further includes at least one dummy notch extending from the respective arcuate surface into the tooth, the first axially extending centerline being in a first position different than a second position of the second axially extending centerline.

In another exemplary embodiment of the present invention, a brush type motor including a stator having a plurality of magnets disposed around an inner periphery of a housing is provided. At least one magnet of the plurality of magnets has an inner partially circumferential surface. The inner circumferential surface is defined by a first radius orthogonally extending from a first axially extending centerline. The brush type motor further includes an armature disposed within an interior region of the stator. The armature has a plurality of teeth. Each tooth of the plurality of teeth has an arcuate surface defined by a second radius orthogonally extending from a second axially extending centerline. At least one tooth of the plurality of teeth is radially closer to the inner circumferential surface of the at least one magnet than the plurality of teeth adjacent to the at least one tooth. Each tooth of the plurality of teeth further includes at least one dummy notch extending from the respective arcuate surface into the tooth. The first axially extending centerline is in a first position different than a second position of the second axially extending centerline, and each tooth of the plurality of teeth is not skewed relative to the second axially extending centerline.

The above features and advantages and other features and advantages of the present invention are readily apparent from the following detailed description for carrying out the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1 is a pictorial view of a brush type motor in accordance with one aspect of the invention;

FIG. 2 is a pictorial view of an armature of the brush type motor of FIG. 1;

FIG. 3 is an enlarged cross-sectional schematic of the brush type motor of FIG. 1;

FIG. 4 is an enlarged schematic of a portion of the cross-sectional schematic of FIG. 3;

FIG. 5 is a table showing exemplary design control parameters associated with brush type motors;

FIG. 6 is another table of exemplary design control parameters utilized in designing brush type motors;

FIG. 7 is a cross-sectional schematic of an exemplary brush type motor;

FIG. 8 is a cross-sectional schematic of another exemplary brush type motor;

FIG. 9 is a graph of first and second cogging torque curves;

FIG. 10 is another graph of third and fourth cogging torque curves; and

FIG. 11 is a schematic of an exemplary motor control system utilized to control the motor of FIG. 1.

### DESCRIPTION OF THE EMBODIMENTS

The following description is merely exemplary in nature and is not intended to limit the present disclosure, application or uses. It should be understood that throughout the drawings, corresponding reference numerals indicate like or corresponding parts and features.

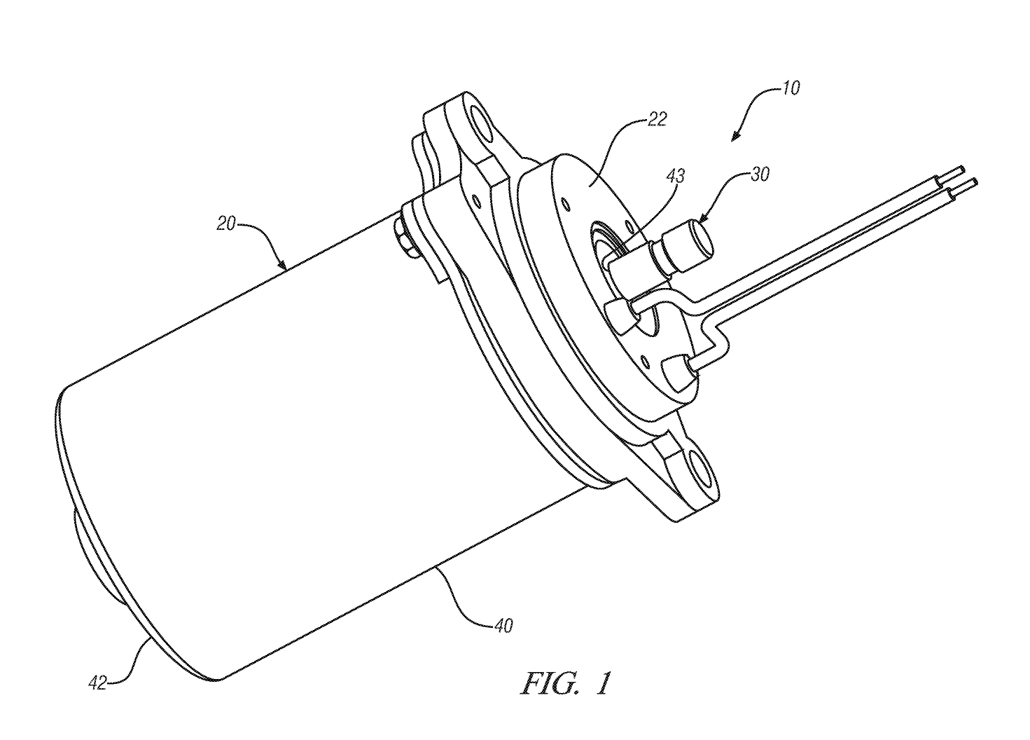

In accordance with an exemplary embodiment of the present invention, and referring to FIGS. 1-3, a brush type motor 10 in accordance with an exemplary embodiment is provided. The brush type motor 10 includes a housing 20, a cover 22, an armature 30, and a stator 32. An advantage of the exemplary brush type motor 10 is that the motor utilizes armature teeth with dummy notches or voids and non-skewed armature teeth and non-skewed stator magnets to minimize cogging torque generated in the motor 10. As a result of the non-skewed armature teeth and the non-skewed stator magnets, the motor 10 is more easily manufactured compared to motors having skewed armature teeth or skewed stator magnets.

The housing 20 is provided to hold the armature 30 and the stator 32 therein. The housing 20 includes a tubular outer wall 40 and an end wall 42 enclosing a first end of the tubular outer wall 40. The cover 22 is configured to be coupled to a second end of the tubular outer wall 40. The cover 22 includes an aperture 43 extending therethrough for allowing a portion of the armature 30 to extend therethrough.

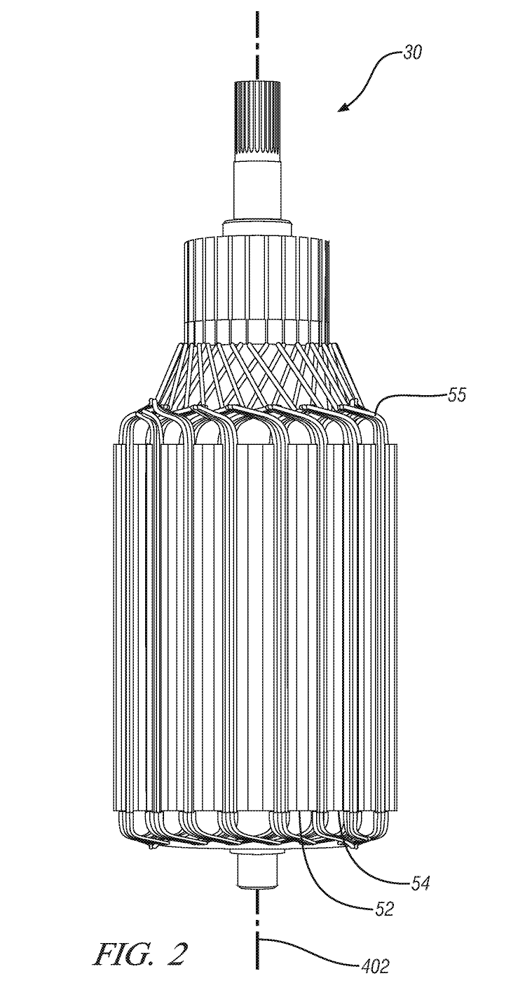

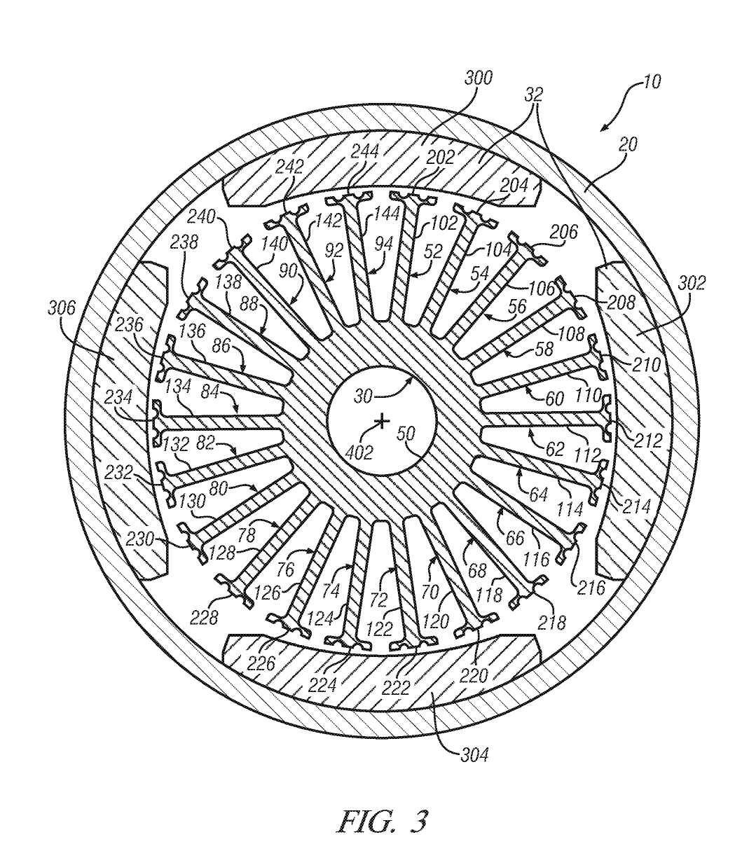

Referring to FIGS. 2 and 3, the armature 30 is disposed within an interior region defined by the stator 32. The armature 30 is configured to rotate about a second axially extending centerline 402 about which the armature 30 is centered. The armature 30 includes a ring-shaped portion 50 and a plurality (in the exemplary embodiment shown, twenty-two) teeth 52, 54, 56, 58, 60, 62, 64, 66, 68, 70, 72, 74, 76, 78, 80, 82, 84, 86, 88, 90, 92, 94 and is constructed of steel or other suitable material. The plurality of teeth 52-94 extending radially outwardly from the centerline 402 are disposed around a circumference of the ring-shaped portion 50 and are spaced apart from each other at about equal distances. The plurality of teeth 52-94 include shaft portions 102, 104, 106, 108, 110, 112, 114, 116, 118, 120, 122, 124, 126, 128, 130, 132, 134, 136, 138, 140, 142, 144, respectively, each having a first end coupled to the ring-shaped portion 50. The plurality of teeth 52-94 further include tooth tip portions 202, 204, 206, 208, 210, 212, 214, 216, 218, 220, 222, 224, 226, 228, 230, 232, 234, 236, 238, 240, 242 and 244, respectively, coupled to second ends of the shaft portions 102-144, respectively. Further, each of the plurality of teeth 52-94 of the armature 30 are not skewed relative to the second axially extending centerline 402 corresponding to the central axis of the armature 30. In an alternative embodiment, the armature 30 could have less than twenty-two teeth or greater than twenty-two teeth.

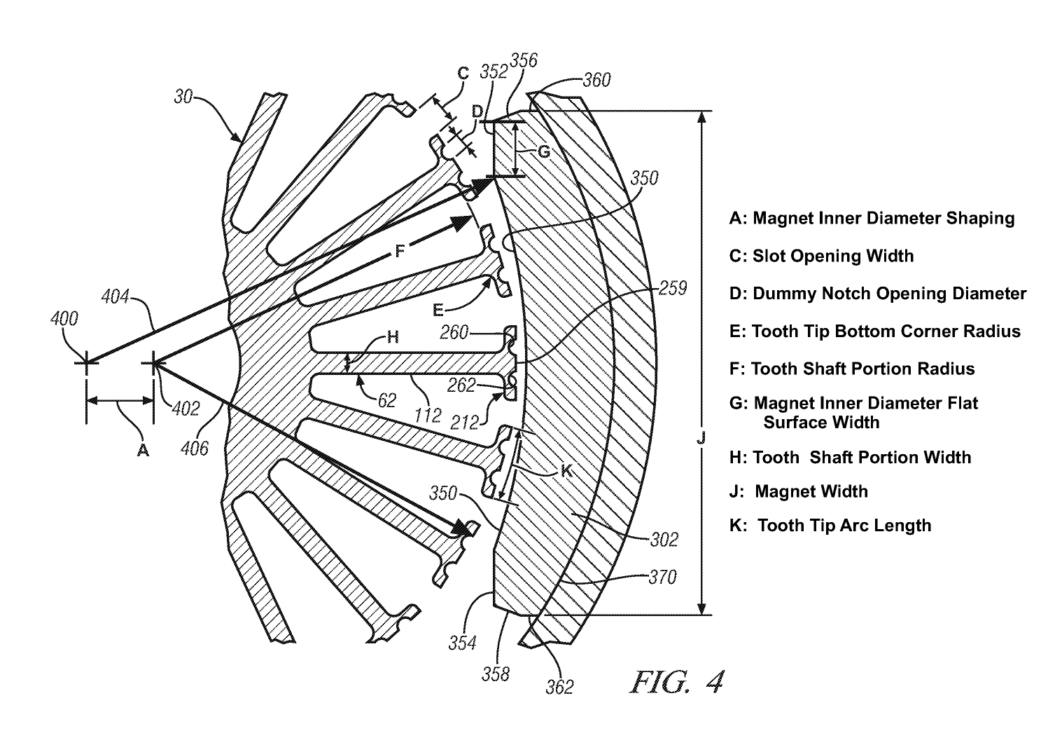

Referring to FIG. 4, since each tooth of the plurality of teeth 52-94 in the armature 30 has a similar configuration, only the tooth 62 will be explained in greater detail below. As shown, tooth 62 includes the shaft portion 112 and the tooth tip portion 212. The tooth tip portion 212 includes an arcuate surface 259 having dummy notches 260, 262 extending from the arcuate surface 259 into the tooth tip portion 212. The arcuate surface 259 is defined by a second radius 406 extending outwardly from the second axially extending centerline 402. In particular, the arcuate surface 259 has a convex shape relative to the second axially extending centerline 402. In one exemplary embodiment, the dummy notches 260, 262 are arcuate shaped. Further, in one exemplary embodiment, each of the dummy notches 260, 262 has a diameter of about 1.0 to about 1.55 millimeters (mm) Of course, other diameters outside of the foregoing range are contemplated. Further, in one exemplary embodiment, the diameter of each dummy notch is in a range of about 10% to about 30% of a tooth tip arc length “K” (see FIG. 4). For example, in particular, the diameter of each dummy notch could be 17.8% of a tooth tip arc length. In an alternative embodiment, the tooth tip portion 212 could have one or more dummy notches 260, 262. Further, in an alternative embodiment, the shape of the one or more dummy notches 260, 262 could vary from that shown on the tooth tip portion 212. For example, the one or more dummy notches could have a triangular shape, a rectangular shape, or an octagonal shape, or some combination thereof Referring to FIG. 3, the tooth 62 is radially closer to the inner circumferential surface of the magnet 302 than the teeth 60, 64 adjacent to the tooth 62 when the tooth 62 is at a first rotational position. As a result, a cogging torque generated in the motor 10 is reduced by such a configuration.

It should be noted that each tooth of the plurality of teeth 52-94 has a corresponding coil, such as a coil 55 for example, disposed around the respective tooth as shown in FIG. 2. Further, during operation, the coils are energized to induce magnetic forces between the plurality of teeth and the stator 32 to induce the armature 30 to rotate about the second axially extending centerline 402.

Referring to FIGS. 3 and 4, the stator 32 includes a plurality of permanent magnets 300, 302, 304, 306 that are disposed about an inner periphery of the housing 20. The magnets 300, 302, 304, 306 extend longitudinally and are not skewed relative to the second axially extending centerline 402 which corresponds to the central axis of the armature 30. As a result, the armature 30 can be more easily manufactured as compared with other designs that require skewed armature teeth.

Since the shape of each of the magnets 300, 302, 304, 306 are substantially similar to one another, only the surfaces of the magnet 302 will be described in greater detail hereinafter. As shown, the magnet 302 includes an inner circumferential surface 350 and flat surfaces 352, 354 disposed at opposite ends of the inner circumferential surface 350. Further, the magnet 302 includes an intermediate surface 356 extending from the flat surface 352, and an end surface 360 extending from the intermediate surface 356. Further, the magnet 302 includes an intermediate surface 358 extending from the flat surface 354, and an end surface 362 extending from the intermediate surface 358. Finally, the magnet 302 includes an outer circumferential surface 370 that extends between the end surfaces 360, 362 and is defined by a radius extending from the second axially extending centerline 402. The inner circumferential surface 350 is defined by the radius 404 extending from the first axially extending centerline 400. As indicated, the tooth shaft portion radius is defined by the radius 406 extending from the second axially extending centerline 402. Because the radius 404 is greater than the radius 406, an adjacent tooth having one or more dummy notches that rotates past the inner circumferential surface 350 has a varying distance from the inner circumferential surface 350 between first and second ends of the magnet 302, resulting in a reduction of cogging torque.

Referring to FIG. 4, several design control parameters utilized in the design of brush type motors will now be explained for purposes of understanding. As shown, a parameter “A” corresponds to a magnet inner diameter shaping and is a linear distance between a first axially extending centerline 400, and the second axially extending centerline 402 that corresponds to a central axis of the armature 30. In one exemplary embodiment, a distance between the first axially extending centerline 400 and the second axially extending centerline 402 is about 5 to about 40 mm. The parameter “C” corresponds to a slot opening distance between adjacent teeth, and the parameter “D” corresponds to a dummy notch opening diameter or size. The parameter “E” corresponds to a tooth tip bottom corner radius, and the parameter “F” corresponds to a tooth shaft portion radius. The parameter “G” corresponds to a magnet inner diameter flat surface width, and the parameter “H” corresponds to a tooth shaft portion width. Further, the parameter “J” corresponds to a magnet width, and the parameter “K” corresponds to a tooth tip arc length.

It should be noted that although magnet 302 has an inner circumferential surface 350 that is defined by a radius 404 extending from the first axially extending centerline 400, each of the other magnets 300, 304, 306 has a unique axially extending centerline at a different position than the centerline 400. Further, each of the other magnets 300, 304, 306 has a respective radius equal to the radius 404 extending from the respective unique axially extending centerline, which defines a respective inner circumferential surface thereof

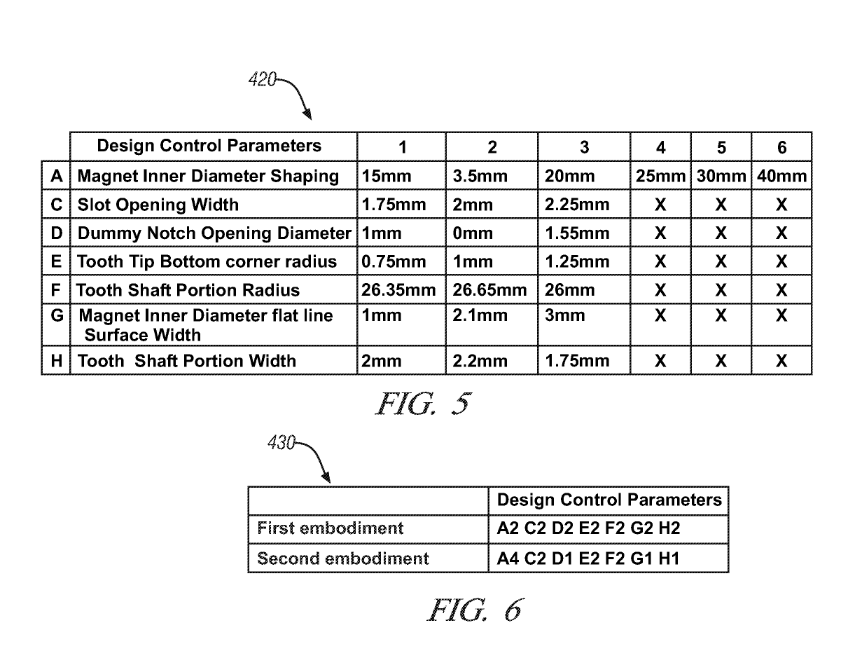

Referring to FIG. 5, a table 420 is illustrated which includes exemplary embodiments of the design control parameters utilized by the inventors herein to develop embodiments of a brush type motor described herein. The row identifiers A, C, D, E, F, G, H in the table 420 correspond to the parameters A, C, D, E, F, G, H illustrated in FIG. 4 discussed above. Further, the column identifiers 1, 2, 3, 4, 5, 6 correspond to the columns in the table 420. Accordingly, when referring to the table 420, both the row identifier and the column identifier is utilized. For example, a designation of C1 when referring to the table 420 corresponds to a slot opening of 1.75 mm, and a designation of C3 corresponds to a slot opening of 2.25 mm Further, the table 420 has “X” indicators in spaces where no values were assigned to a specific row and column position.

Referring to FIG. 6, the table 430 indicates design control parameters utilized in designing first and second embodiments of brush type motors. The first embodiment of a brush type motor (not shown) has teeth with no dummy notches; and the second embodiment of the brush type motor 10 has teeth with dummy notches. The first embodiment of the brush type motor, which will be used for comparison purposes herein, utilized the design parameters A2, C2, D2, E2, F2, G2, H2 identified in the table 420. The second embodiment of the brush type motor 10 utilized the design control parameters A4, C2, D1, E2, F2, G1, H1 identified in the table 420.

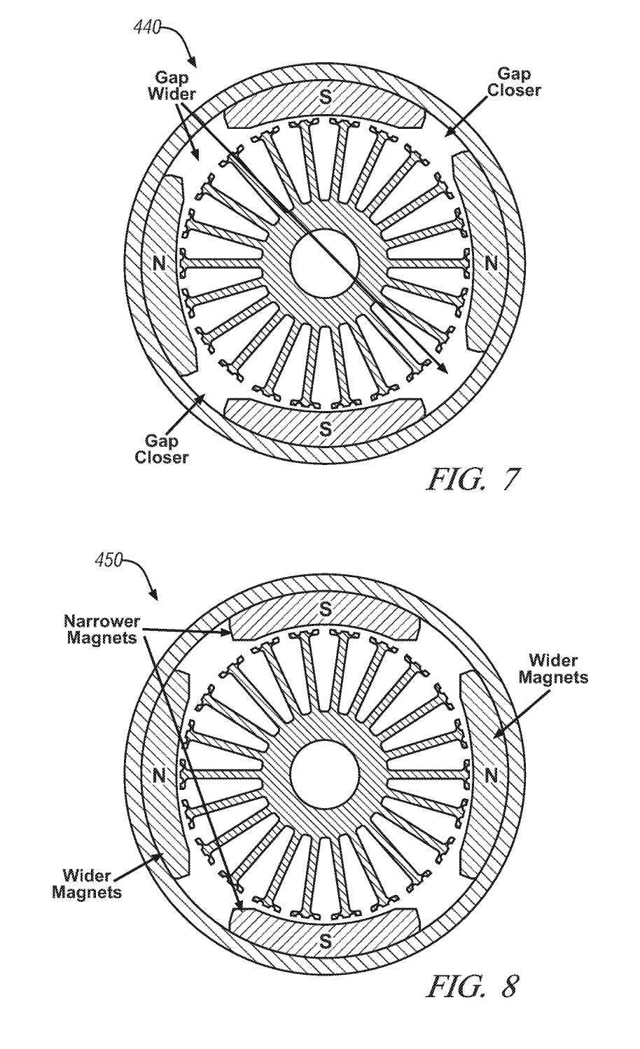

During manufacture of brush type motors, two variability factors can be encountered. In particular, a gap size between stator magnets may differ a relatively small amount between adjacent magnets. Further, a placement of the stator magnets can differ a relatively small amount from desired positions. Accordingly, exemplary embodiments of brush type motors illustrating the foregoing variability factors will be explained below with reference to FIGS. 7 and 8. Further, the second embodiment of the brush type motor 10 described above has reduced cogging torque even if one or more of the variability factors is present in the motor.

Referring to FIG. 7, a schematic of an exemplary brush type motor 440 that has a varying gap size between magnets disposed around a periphery of the stator is provided. In particular, the motor 440 has two North magnetic poles misplaced by 1 degree counter-clockwise and 2 South magnetic poles mislocated by 1 degree clockwise. This type of varying gap size can occur in manufacturing processes. As will be discussed below, the second embodiment of the brush type motor 10 described in FIG. 6 can reduce cogging torque even if the magnets are slightly mislocated in the stator thereof

Referring to FIG. 8, a schematic of an exemplary brush type motor 450 that has varying magnet widths is provided. In particular, two North magnetic poles are wider than a desired width by 0.5 mm and the two South magnetic poles are narrower than a desired width by 0.5 mm. As will be discussed below, the second embodiment of the brush type motor 10 described in FIG. 6 can reduce cogging torque even if the magnets in the stator have varying magnet widths.

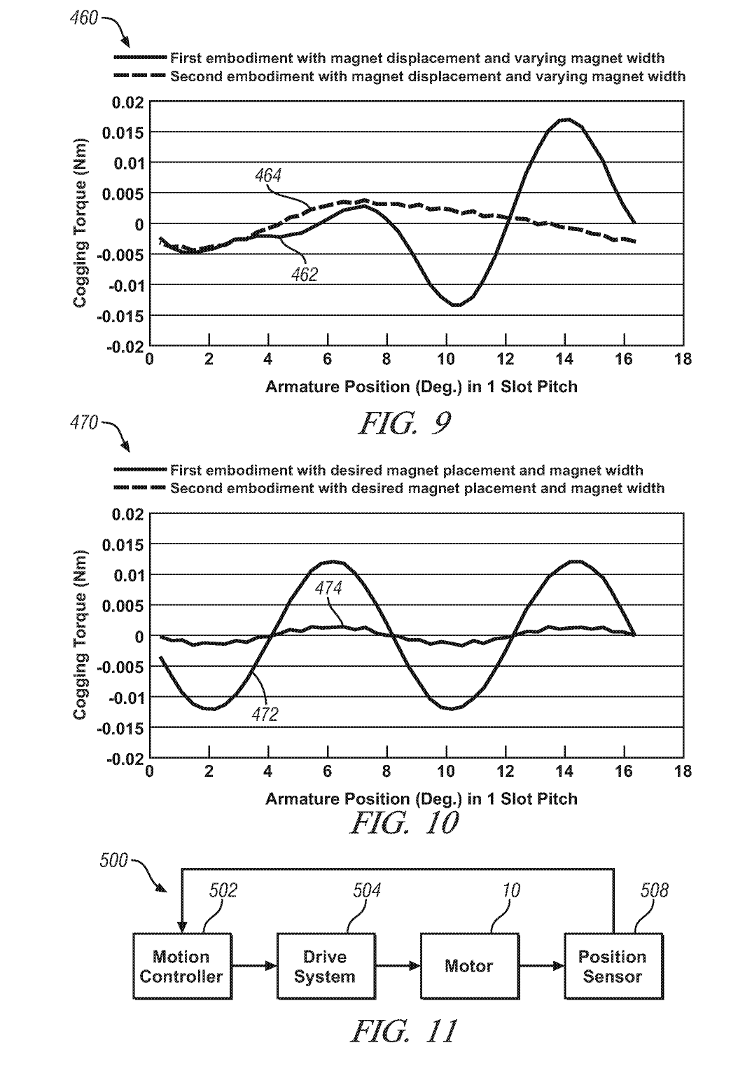

Referring to FIG. 9, a graph 460 having curves 462 and 464 indicating cogging torque versus armature position for the first embodiment of a brush type motor (not shown) and the second embodiment of the brush type motor 10, respectively, is illustrated. The curve 462 indicates a cogging torque of the first embodiment of the brush type motor having no dummy notches and having design control parameters of the “first embodiment” shown in table 430 of FIG. 6. This first embodiment also has magnet misplacement and varying magnet widths as shown in the stators in FIGS. 7 and 8. The curve 464 indicates a cogging torque of the second embodiment of the brush type motor 10 and having design control parameters of the “second embodiment” shown in table 430 of FIG. 6, except that the motor has magnet misplacement and varying magnet widths. As shown by the curves 462, 464, the second embodiment of the brush type motor 10 has a substantially decreased cogging torque as compared to the first embodiment of the brush type motor.

Referring to FIG. 10, a graph 470 having curves 472 and 474 indicating cogging torque versus armature position for another first embodiment of the brush type motor and another second embodiment of the brush type motor, respectively, is illustrated. The curve 472 indicates a cogging torque of the first embodiment of the brush type motor having no dummy notches with desired magnet placement and desired magnet widths and having design control parameters of the “first embodiment” shown in table 430 of FIG. 6. The curve 474 indicates a cogging torque of the second embodiment of the brush type motor 10 having desired magnet placement and desired magnet widths and having design control parameters of the “second embodiment” shown in table 430 of FIG. 6. As shown by the curves 472, 474, the second embodiment has a substantially decreased cogging torque as compared to the first embodiment.

The brush type motor 10 disclosed herein provides a substantial advantage over other brush type motors. In particular, the brush type motor 10 provides a technical effect of utilizing (i) an armature having teeth with one or more dummy notches; (ii) a stator magnet with an inner circumferential surface defined by a radius extending from an axially extending centerline that is offset from a central axis of the armature, and (iii) unskewed armature teeth and unskewed stator magnets relative to a central axis of the armature, to reduce cogging torque in the motors.

Referring to FIG. 11, an exemplary motor control system 500 used to control the motor 10 is illustrated. The motor control system 500 includes a motion controller 502, a drive system 504 and a position sensor 508. The motion controller 502 generates commands to induce the drive system 504 to generate drive signals. The drive signals are received by the armature coils of the motor 10 to induce the armature 30 to rotate in either a clockwise or counterclockwise direction. The position sensor 508 detects a rotational position of the armature and generates a position signal indicative of the rotational position that is received by the motion controller 502. The motion controller 502 iteratively generates the commands based on the received position signal.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed contemplated for carrying out this invention, but that the invention will include all embodiments falling within the scope of the present application.

What is claimed is:

1. A brush type motor, comprising:
a stator having at least one magnet having an inner partially circumferential surface, the inner circumferential surface defined by a first radius orthogonally extending from a first axially extending centerline; and
an armature disposed within an interior region of the stator, the armature having a plurality of teeth, each tooth of the plurality of teeth having an arcuate surface defined by a second radius orthogonally extending from a second axially extending centerline, at least one tooth of the plurality of teeth being radially closer to the inner circumferential surface of the at least one magnet than the plurality of teeth adjacent to the at least one tooth, each tooth of the plurality of teeth further having at least one dummy notch extending from the respective arcuate surface into the tooth, the first axially extending centerline being in a first position different than a second position of the second axially extending centerline.

2. The brush type motor of claim 1, wherein each tooth of the plurality of teeth is not skewed relative to the second axially extending centerline.

3. The brush type motor of claim 1, wherein the at least one magnet comprises a plurality of magnets, each of the magnets not being skewed relative to the second axially extending centerline.

4. The brush type motor of claim 1, wherein each tooth of the plurality of teeth has first and second dummy notches.

5. The brush type motor of claim 4, wherein the first dummy notch is arcuate shaped.

6. The brush type motor of claim 5, wherein the first dummy notch has a diameter that is 10-30% of a tooth tip arc length.

7. The brush type motor of claim 1, wherein the first radius is greater than the second radius.

8. The brush type motor of claim 1, wherein a distance between the first axially extending centerline and the second axially extending centerline is 5 to 40 millimeters.

9. The brush type motor of claim 1, wherein the second axially extending centerline is a central axis of the armature.

10. A brush type motor, comprising:
a stator having a plurality of magnets disposed around an inner periphery of a housing, at least one magnet of the plurality of magnets having an inner partially circumferential surface, the inner circumferential surface being defined by a first radius orthogonally extending from a first axially extending centerline; and
an armature disposed within an interior region of the stator, the armature having a plurality of teeth, each tooth of the plurality of teeth having an arcuate surface defined by a second radius orthogonally extending from a second axially extending centerline, at least one tooth of the plurality of teeth being radially closer to the inner circumferential surface of the at least one magnet than the plurality of teeth adjacent to the at least one tooth, each tooth of the plurality of teeth further having at least one dummy notch extending from the respective arcuate surface into the tooth, the first axially extending centerline being in a first position different than a second position of the second axially extending centerline, and each tooth of the plurality of teeth is not skewed relative to the second axially extending centerline.

11. The brush type motor of claim 10, wherein each magnet of the plurality of magnets is not skewed relative to the second axially extending centerline.

12. The brush type motor of claim 10, wherein each tooth of the plurality of teeth has first and second dummy notches.

13. The brush type motor of claim 12, wherein the first dummy notch is arcuate shaped.

14. The brush type motor of claim 13, wherein the first dummy notch has a diameter that is 10-30% of a tooth tip arc length.

15. The brush type motor of claim 10, wherein the first radius is greater than the second radius.

16. The brush type motor of claim 10, wherein a distance between the first axially extending centerline and the second axially extending centerline is 5 to 40 millimeters.

17. The brush type motor of claim 10, wherein the second axially extending centerline is a central axis of the armature.
